(19) United States
(12) Patent Application Publication
(10) Pub. No.: US 2010/0159364 A1
(43) Pub. Date: Jun. 24, 2010

(54) FUEL CELL CATHODES

(75) Inventors: Gene LEWIS, London (GB); John Kilner, (US); Tom McColm, London (GB)

Correspondence Address: MILES & STOCKBRIDGE PC, 1751 PINNACLE DRIVE, SUITE 500, MCLEAN, VA, 22102-3833, US

(73) Assignee: CERES INTELLECTUAL PROPERTY COMPANY LIMITED

(21) Appl. No.: 12/716,982

(22) Filed: Mar. 3, 2010

Related U.S. Application Data
(63) Continuation of application No. 11/814,764, filed on Mar. 24, 2008, now abandoned.

(30) Foreign Application Priority Data
Jan. 25, 2005 (GB) 0501590.4

(51) Int. Cl. H01M 4/02; B05D 5/00; H01M 4/04

(52) U.S. Cl. 429/523; 427/115

(57) ABSTRACT

The present invention relates to a method of producing a fuel cell cathode, fuel cell cathodes, and fuel cells comprising same.

The present invention relates to a method of producing fuel cell cathodes and to fuel cell cathodes.

Solid oxide fuel cell cathodes based on LSCF (an example of which is La_{0.6}Sr_{0.4}Co_{0.2}Fe_{0.8}O₃) are common in the field. This material exhibits the necessary mixed electronic and ionic conductivity and chemical stability for functioning as an SOFC cathode at typical operating temperatures.

Conventional processing of LSCF based cathode systems in general involves the fabrication of a single green ceramic layer by an established ceramic processing route. Such routes include tape casting, screen-printing, doctor blading and electrophoretic deposition. The green processed layer is subsequently sintered in air at a temperature in the range 900-1000° C. in order to retain a high porosity.

Examples of these prior-art processes for preparing LSCF cathodes include screen printing and firing in air at 950° C. for 2 hours (S. P. Jiang, A comparison of O₂ reduction reactions on porous (La,Sr)MnO₃ and (La,Sr)(Co,Fe)O₃ electrodes—Solid State Ionics 146 (2002) 1-22), LSCF sol screen printing and heating in air at 900° C. for 4 hours (J. Liu, A. Co, S. Paulson, V. Birss, Oxygen reduction at sol-gel derived La_{0.8}Sr_{0.2}Co_{0.8}Fe_{0.2}O₃ cathodes—Solid State Ionics, available online 3 Jan. 2006), wet dropping LSCF sol-precursor as the working electrode and heating in air at 900° C. for 4 hours (Liu et al. 2006, supra), spin casting LSCF slurry and sintering in air at temperature ranges from 900-1250° C. for 0.2-4 hours (E. Murray, M. Sever, S. Barnett, Electrochemical performance of (La,Sr)(Co,Fe)O₃—(Ce,Gd)O₃ composite cathodes—Solid State Ionics 148 (2002) 27-34), and electrostatic spray assisted vapour deposition (ESAVD) technique for thin film LSCF heating at 300-400° C. followed by brushing on LSCF tape cast slurry and drying in air at 1000° C. for 12 minutes (J-M Bae, B. Steele, Properties of La_{0.6}Sr_{0.4}Co_{0.2}Fe_{0.8}O_{3-δ} (LSCF) double layer cathodes on gadolinium-doped cerium oxide (CGO) electrolytes—Solid State Ionics 106 (1998) 247-253).

Notably, conventional LSCF cathode processing requires that the sintering step is carried out in air. Conventional wisdom to date supports the view that the firing of LSCF cathodes in reducing (low oxygen partial pressure) atmospheres cannot be satisfactorily executed because extensive aggressive reduction of the LSCF by hydrogen is suspected to induce a partial phase change in the cathode. This breakdown from a single phase is detrimental to both cathode function and structure and is generally deemed unacceptable for subsequent cathode and fuel cell performance.

In summary, conventional LSCF processing involves the firing of a green LSCF layer in air between 900° C. and 1000° C. For the majority of current SOFC designs this processing route does not present any serious problems. For these all-ceramic (anode or electrolyte supported) fuel cell systems, which possess YSZ electrolytes, neither the cathode sintering atmosphere nor the cathode sintering temperature are detrimental to cell integrity. For all such systems, the electrolyte is fired in air at 1400° C. or above and if the anode is nickel-based (generally a Ni/YSZ cermet), the anode is left in its fully oxidised state throughout the entirety of cell fabrication, and the nickel oxide is not reduced down to metallic nickel until the first operating cycle of the cell. Cells of this type are typically operated in the 700-900° C. temperature range.

For a metal supported SOFC that operates below 700° C. (as described in e.g. GB 2368450), which possesses a Ni/CGO cermet anode in the reduced state and a CGO electrolyte fired in the region of 1000° C., conventional cathode firing under air poses a threat to the maintenance of cell integrity during cell processing. The principal source of potential problems is anode re-oxidation and the associated volume changes during cathode firing in air, which can result in catastrophic electrolyte failure due to cracking and/or delaminating and/or rupture. Secondary to this problem, because of the supporting steel substrate, issues concerning extensive steel oxidation and volatile steel species migration also arise when processing at high temperatures (such as processing temperatures above 1000° C.). In addition to the stated problems with maintaining cell integrity during cathode firing, a further consideration exists. Due to the significant electronic conductivity of CGO at temperatures above 650° C. the cell design as described in GB 2368450 requires a cathode to function acceptably in the lower temperature range of 500-600° C.

Whilst these problems do not prevent the operation of the fuel cells, it is desirable to improve and simplify component manufacture and to improve fuel cell performance.

The present invention aims to overcome the prior art disadvantages and to provide an improved cathode fabrication route and cathodes fabricated by same.

According to a first aspect of the present invention there is provided a method of producing a fuel cell cathode, the method comprising the steps of:
providing a primary layer comprising LSCF;
(ii) isostatically pressing said primary layer in the pressure range 10-300 MPa;
(iii) providing on said primary layer a current collecting layer comprising a perovskite-based electrode, to define a bi-layer cathode; and
(iv) firing said bi-layer cathode in a reducing atmosphere.

Preferably, the primary layer is provided on an electrolyte, more preferably a dense electrolyte, more preferably as dense CGO electrolyte.

Preferably, the primary layer on the electrolyte is provided on an anode, more preferably a porous anode, more preferably still a Ni-CGO porous anode.

The anode is preferably provided on a substrate, more preferably a porous substrate, more preferably still a porous ferritic stainless steel substrate.

In certain embodiments, the perovskite-based electrode comprises LSCF. Thus, the primary layer and the current collecting layer can both comprise LSCF.

Particular examples of primary layers are those comprising an LSCF/CGO composite.

In certain embodiments, the primary layer has a thickness of about 0.5-20 μm, more particularly about 1-10 μm, more particularly about 1.5-5 μm.

In certain embodiments, the isostatic pressing is cold isostatic pressing.

In various embodiments, the isostatic pressing is performed at a pressure of about 10-300 MPa, more particularly about 20-100 MPa, more particularly about 30-70 MPa.

In various embodiments, the current collecting layer has a thickness of about 5-100 μm, more particularly about 10-70 μm, more particularly about 30-50 μm.

In certain embodiments, the step of firing the bi-layer cathode is performed at a temperature of about 700-900° C., more particularly at about 800-900° C.

In certain embodiments, the bi-layer cathode is fired in the pO₂ range of about 10⁻¹⁰-10⁻²⁰.

In certain embodiments, the bi-layer cathode is fired under a dilute, buffered H₂/H₂O atmosphere.

In certain embodiments, bi-layer cathode is re-oxidised after being fired in said reducing atmosphere, particularly at a temperature of about 700° C.

An example of a way in which the methods of the present invention can be used to make the fuel cell cathodes includes the following “Process 1” in which the following steps are performed:
(i) An LSCF/CGO composite ‘active’ layer (i.e. primary layer) is laid down by e.g. spray deposition or screen-printing;
(ii) Cold isostatic pressing of the ‘active’ (i.e. primary) layer is then performed. In the field of SOFC processing, to isostatically press an electrode when considering microstructure is counter-intuitive. A general theme running through electrode processing is a desire to create and preserve porosity due to mass transport and gas access considerations. Cold Isostatic Pressing (CIP) is a technique normally associated with the removal of porosity to create a denser product. In this case, CIP is employed in order to improve the contact between electrolyte and cathode to enable a firing temperature below typical LSCF cathode firing temperatures. Results revealed that the improvement in performance gained by pressing, and hence improved cathode-electrode contact, significantly outweighed any degradation due to loss of cathode porosity;
(iii) An LSCF current collecting layer is applied by e.g. spray deposition or screen printing, creating a green bi-layer cathode;
(iv) The green bi-layer cathode is fired under a dilute, buffered H₂O/H₂ atmosphere in the pO₂ range 10⁻¹⁰-10⁻²⁰. As discussed above, for LSCF based cathode systems, conventional wisdom is of the view that low pO₂ firing is not possible due to extensive chemical decomposition and subsequent cathode failure. Due to anode re-oxidation concerns, the use of low pO₂ cathode firing during processing was explored by the inventors, and the results were not as would be expected from the priori art, and instead were highly positive;
(v) Re-oxidation of the cathode. The decomposition of the isostatically pressed LSCF structure in the low pO₂ cathode firing atmosphere followed by re-oxidation, resulted in a cathode with a structure which outperformed conventional LSCF cathodes. The reduction of the pressed structure followed by re-oxidation induced a proportion, structure and scale of porosity which significantly increased cathode triple-phase boundary length and hence cathode performance.

Although the exact structural and physical nature of the cathodes thus produced are not fully understood at present, the results achieved are a notable improvement over the prior art. Without wishing to be limited or bound by speculation, it is believed that a factor contributing to the lower temperature performance enhancement lies in the reduction of the cathode ‘active’ layer during cathode firing. The reaction produces a highly porous microstructure with porosity believed to be on the nano-scale. This microstructure possesses a vastly increased active surface area close to the electrolyte surface, and this increased specific surface area manifests itself as greatly reduced area specific resistance (ASR).

In other embodiments, the bi-layer cathode is fired under a dilute air Argon or air Nitrogen atmosphere.

In such embodiments, the bi-layer cathode can be fired in the pO₂ range of about 10⁻¹-10⁻¹⁰, for example in the pO₂ range of about 10⁻¹-10⁻⁵.

The re-oxidisation step described for Process 1 need not be performed in such embodiments.

An example of a way in which the methods of the present invention can be used to make the fuel cell cathodes includes the following “Process 2” in which the following steps are performed:
(i) As per Process 1;
(ii) As per Process 1;
(iii) As per Process 1;
(iv) The green bi-layer cathode is fired under a dilute air in diluent gas (such a diluent gas being Argon or Nitrogen) environment in the pO₂ range 10⁻¹-10⁻¹⁰. The additional advantage of this processing step as compared to step (iv) of Process 1 is that is occurs in a more oxidising environment, resulting in a greater number of ion vacancies in the cathode lattice, greater cathode conductivity, lower ASR and thus greater cell operating performance. In addition, it removes the need for a re-oxidation step (as in Process 1 step (v)), as this can occur when the fuel cell is first used without any degrading or structural risks associated with re-oxidation from a more reduced state.

Thus, there is no requirement for Process 1 step (v).

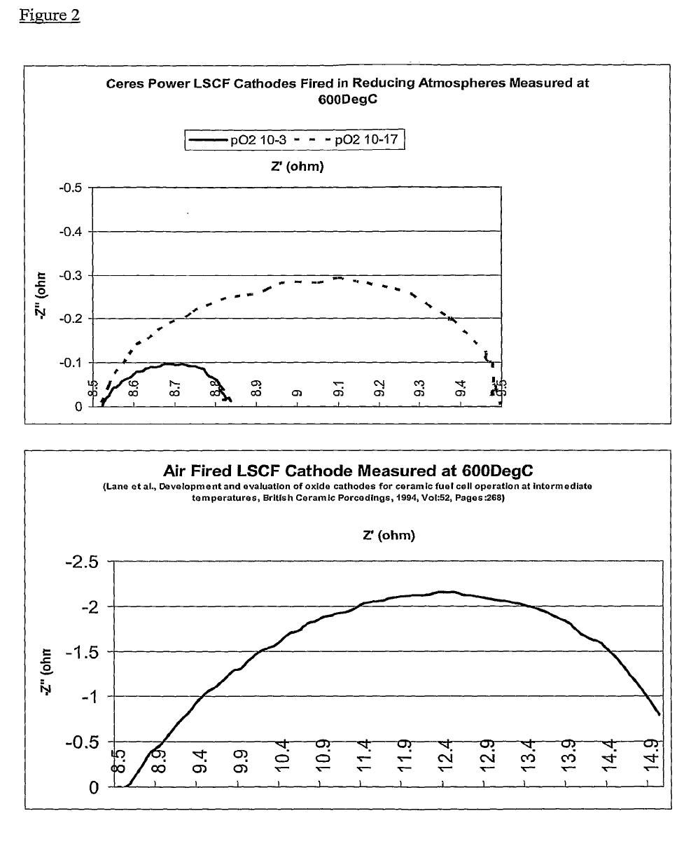

The method of the present invention produces a functional, bi-layer cathode possessing a unique and beneficial structure having a microporous structure in the current collector and active (i.e. primary) layers capable of performing well in the 500-600° C. operating temperature range. Cathodes processed by this route exhibited exceptional performance as shown in FIG. 2, and when used with the metal supported IT-SOFC fuel cell of GB 2368450 they maintained their integrity throughout processing and subsequent fuel cell operation.

Notable advantages over the prior art achieved by the present invention include:
(i) Previously unreported excellent cathode performance in the operating temperature range 500-600° C.;
(ii) The preservation of metallic cell components and hence electrolyte integrity throughout cathode processing; and
(iii) The creation of a micro-porous cathode layer in direct contact with the electrolyte surface which significantly reduces ASR.

According to a second aspect of the present invention, there is provided a bi-layer fuel cell cathode comprising first and second layers, said first layer comprising LSCF, said second layer comprising a perovskite-based electrode, one of said first and second layers being isostatically pressed.

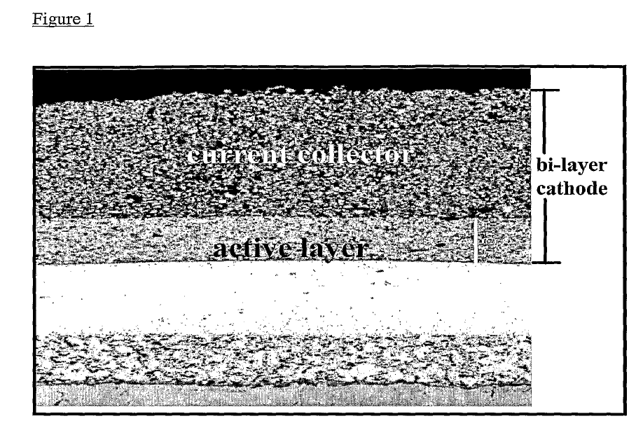

Such hi-layer fuel cell cathodes have a novel microstructure, an example of which is shown in FIG. 1 and which, as detailed above, enables previously unreported and unexpectedly high performance in the 500-600° C. temperature range.

In particular, the bi-layer fuel cell cathode can be made according to the method of the present invention. Also provided according to the present invention is a fuel cell incorporating a cathode according to the present invention.

The invention will be further apparent from the following description with reference to the several figures of the accompanying drawings which show, by way of example only, methods of manufacture of bi-layer fuel cell cathodes, and bi-layer fuel cell cathodes made according to same. Of the Figures:

FIG. 1 shows a cross-sectional scanning electron microscope (SEM) image of a substrate-supported fuel cell comprising a bi-layer cathode structure, a dense electrolyte, a porous anode structure and a metal substrate. The top layer of the bi-layer cathode structure is the current collector, and the layer underneath is the primary layer;

FIG. 2 shows (bottom) a Cole-Cole plot of a conventional air fired LSCF cathode measured at 600° C., showing a relatively high ASR; and (top) Cole-Cole plots of two LSCF cathodes made according to the present invention—one (dashed line) fired in pO₂ of 10⁻¹⁷ and one (solid line) fired in pO₂ of 10⁻³, both measured at 600° C., showing significantly lower ASR values. X-axes show Z′ (ohm). Y-axes show Z″ (ohm); and

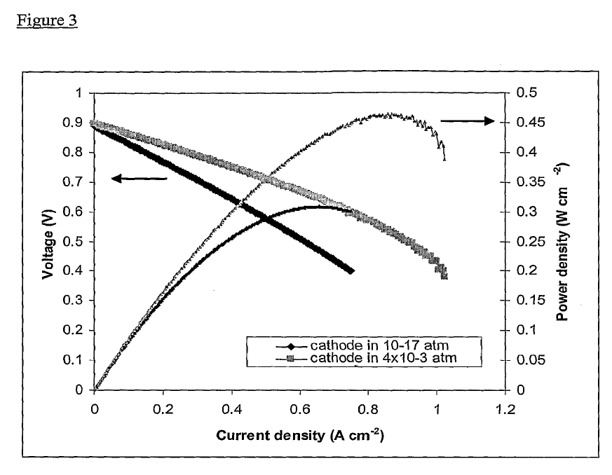

FIG. 3 shows the differing power densities obtained using a fuel cell of GB 2368450 made with an LSCF cathode sintered at a pO₂ of 10⁻¹⁷ atm as per Process A (below) and for a LSCF cathode sintered at a pO₂ of 10⁻³ atm as per Process B (below). Data was obtained at 600° C. in wet 97% H₂ and flowing air. X-axis shows current density (A cm⁻²); Y-axes show (left, for curves originating at (0,0.9)) voltage (V), and (right, for curves originating at (0,0)) power density (W cm⁻²). Upper curve originating at (0,0.9) shows cathode at a pO₂ of 4×10⁻³ atm; lower curve originating at (0,0.9) shows cathode at a pO₂ of 10⁻¹⁷ atm; upper curve originating at (0,0) shows cathode at a pO₂ of 4×10⁻³ atm; lower curve originating at (0,0) shows cathode at a pO₂ of 10⁻¹⁷ atm.

A symmetrical LSCF electrode half-cell on a CGO support was prepared by Process 1 and another by Process 2 (above).

Following the Process 1 route, the following process (Process A) was performed. Firstly, an active LSCF layer of 5 μm was screen-printed on a CGO electrolyte, and cold isostatic pressing to 50 MPa performed. A 35 μm current collector layer of LSCF was screen-printed on to define a bi-layer cathode, and the cathode assembly was fired in a H₂O/H₂ reducing atmosphere of 10⁻¹⁷ at 900° C. for 1 hour. The cathode was subsequently heated in air at 700° C. for 30 minutes prior to being used and measurement taking place.

Following the Process 2 route, involving firing in a slightly reducing atmosphere, the following process (Process B) was performed. Firstly, an active LSCF layer of 5 μm was screen-printed on a CGO electrolyte, and cold isostatic pressing to 50 MPa performed. A 35 μm current collector layer of LSCF was then screen-printed on to define a bi-layer cathode, and the cathode assembly was fired in Ar/air reducing atmosphere of 10⁻³ at 900° C. for 1 hour. No subsequent cathode conditioning in air was required.

Cole-Cole plots generated from the measurements of the cathodes (FIG. 2, top) show the effect of these processing routes over a standard air fired LSCF cathode (FIG. 2, bottom) (taken from measurements at 600° C. for a La_{0.6}Ca_{0.4}Fe_{0.8}Co_{0.2}O₃ cathode on Ce_{0.9}Sm_{0.1}O_{2-δ} electrolyte—Kilner J A, Lane J A, Fox H, Development and evaluation of oxide cathodes for ceramic fuel cell operation at intermediate temperatures, British Ceramic Proceedings, 1994, Vol: 52, Page: 268). The reducing atmosphere firing Z′ measurements have been normalised to 8.52 ohm to provide consistency in presentation on the x-axis. This normalisation is required as the absolute values of the measurements depend on the substrate type, but the impedance response (and the resulting measurement changes) are only down to the electrode and are not affected by the substrate itself.

The results show ASR values of over 3 Ω/cm² for the air fired cathode, less than 0.5 Ω/cm² for the higher reducing firing and less than 0.15 Ω/cm² for the slightly reducing atmosphere, thus showing the advantages of being able to fire LSCF cathodes in a partially reducing atmosphere.

Similar levels of ASR improvement have been produced on actual CGO electrolyte IT-SOFC fuel cells operating at 550-600° C. FIG. 3 shows the results, with a maximum power density of 0.465 W/cm² from the second cathode process compared to 0.32 W/cm² from the first cathode process.

The structure of the cathodes obtained using Process A is shown in FIG. 1. From top to bottom, the first (black) layer is air; the second layer is current collector; the third layer is the active (i.e. primary) layer; the second and third layers together define the bi-layer cathode; the fourth layer is the dense CGO electrolyte; the fifth layer is the Ni-CGO anode; and the sixth (bottom) layer is the ferritic stainless steel substrate.

It will be appreciated that it is not intended to limit the present invention to the above examples only, many variants being readily apparent to a person of ordinary skill in the art without departing from the scope of the appended claims.

1. A method of producing a fuel cell cathode, the method comprising the steps of:
(i) providing a primary layer comprising LSCF;
(ii) isostatically pressing said primary layer in the pressure range 10-300 MPa;
(iii) providing on said primary layer a current collecting layer comprising a perovskite-based electrode, to define a bi-layer cathode; and
(iv) firing said bi-layer cathode in a reducing atmosphere.

2-25. (canceled)

26. A bi-layer fuel cell cathode comprising first and second layers, said first layer comprising LSCF, said second layer comprising a perovskite-based electrode, one of said first and second layers being isostatically pressed.

27-29. (canceled)

30. A method according to claim 1, wherein said perovskite-based electrode comprises LSCF.

31. A method according to claim 1, said primary layer comprising an LSCF/CGO composite.

32. A method according to claim 1, said primary layer having a thickness of about 0.5-20 μm.

33. A method according to claim 32, said primary layer having a thickness of about 1-10 μm.

34. A method according to claim 33, said primary layer having a thickness of about 1.5-5 μm.

35. A method according to claim 1, said isostatic pressing being cold isostatic pressing.

36. A method according to claim 1, said isostatic pressing being performed at a pressure of about 10-300 MPa.

37. A method according to claim 36, said isostatic pressing being performed at a pressure of about 20-100 MPa.

38. A method according to claim 37, said isostatic pressing being performed at a pressure of about 30-70 MPa.

39. A method according to claim 1, said current collecting layer having a thickness of about 5-100 μm.

40. A method according to claim 39, said current collecting layer having a thickness of about 10-70 μm.

41. A method according to claim 40, said current collecting layer having a thickness of about 30-50 μm.

42. A method according to claim 1, wherein said bi-layer cathode is fired at a temperature of about 700-900° C.

43. A method according to claim 42, wherein said bi-layer cathode is fired at a temperature of about 800-900° C.

44. A method according to claim 1, wherein said bi-layer cathode is fired in the pO₂ range of about 10⁻¹⁰-10⁻²⁰.

45. A method according to claim 44, wherein said bi-layer cathode is fired under a dilute, buffered H₂/H₂O atmosphere.

46. A method according to claim 1, wherein said bi-layer cathode is re-oxidised after being fired in said reducing atmosphere.

47. A method according to claim 46, wherein said bi-layer cathode is re-oxidised at a temperature of about 700° C.

48. A method according to claim 1, wherein said bi-layer cathode is fired under a dilute air Argon or air Nitrogen atmosphere.

49. A method according to claim 48, wherein said bi-layer cathode is fired in the pO₂ range of about 10⁻¹-10⁻¹⁰.

50. A method according to claim 49, wherein said bi-layer cathode is fired in the pO₂ range of about 10⁻¹-10⁻⁵.

51. A method according to claim 1, wherein each of said layers is deposited by spray deposition or screen-printing.

52. A fuel cell cathode produced by a method comprising the steps of:
(i) providing a primary layer comprising LSCF;
(ii) isostatically pressing said primary layer in the pressure range 10-300 MPa;
(iii) providing on said primary layer a current collecting layer comprising a perovskite-based electrode, to define a bi-layer cathode; and
(iv) firing said bi-layer cathode in a reducing atmosphere.

53. A fuel cell cathode according to claim 52, said primary layer having a thickness of about 0.5-20 μm.

54. A fuel cell cathode according to claim 52, said isostatic pressing being performed at a pressure of about 10-300 MPa.

55. A fuel cell cathode according to claim 52, said current collecting layer having a thickness of about 5-100 μm.

56. A fuel cell cathode according to claim 52, wherein said bi-layer cathode is fired at a temperature of about 700-900° C.

57. A fuel cell cathode according to claim 52, wherein said bi-layer cathode is re-oxidised after being fired in said reducing atmosphere.

58. A bi-layer fuel cell cathode according to claim 26, said first and second layers each comprising LSCF.

59. A fuel cell comprising a fuel cell cathode, said fuel cell cathode including first and second layers, said first layer comprising LSCF, said second layer comprising a perovskite-based electrode, one of said first and second layers being isostatically pressed.
